(19) United States
(12) Patent Application Publication
(10) Pub. No.: US 2025/0357679 A1
(43) Pub. Date: Nov. 20, 2025

(54) WINDOWED RADIO FREQUENCY CIRCUIT MODULES FOR USE WITH TILE ARRAY PACKAGES

(71) Applicant: Qorvo US, Inc., Greensboro, NC (US)

(72) Inventors: Salvatore Finocchiaro, Dallas, TX (US); Bror Peterson, Fairview, TX (US)

(21) Appl. No.: 19/183,484

(22) Filed: Apr. 18, 2025

Related U.S. Application Data
(60) Provisional application No. 63/647,848, filed on May 15, 2024.

(51) Int. Cl. H01Q 21/06; H01Q 1/02; H01Q 23/00

(52) U.S. Cl. CPC H01Q 21/065; H01Q 1/02; H01Q 23/00

(57) ABSTRACT

Disclosed herein are windowed radio frequency circuit modules for use with tile array packages and methods of configuration, assembly, and use of such modules and packages. For example, an apparatus is disclosed. In some embodiments, the apparatus includes a planar laminate having a window, wherein the planar laminate has a first side and a second side. The apparatus may further include a plurality of radio frequency circuit elements interconnected and distributed between the first side and the second side; and a plurality of chip pads on the first side. In addition, the apparatus may be configured to connect to an electronics assembly via the plurality of chip pads, wherein the electronics assembly comprises a beamformer integrated circuit, and wherein the apparatus is configured such that, after connection with the electronics assembly, the beamformer integrated circuit extends into the window.

### CROSS-REFERENCE TO RELATED APPLICATION(S)

The present application claims the benefit of U.S. Provisional Application No. 63/647,848, filed May 15, 2024, which is incorporated herein by reference in its entirety.

### TECHNICAL FIELD

The present disclosure relates generally to tiled antenna array architectures that implement beamforming.

### BACKGROUND

Antenna array systems, such as multi-function active electronically scanned arrays (AESAs), can be used in various applications, such as radar, communications, electronic surveillance and electronic attack functions. Antenna array systems are being called upon to operate using increasing operating frequencies, transmit power, receive sensitivity, and bandwidth, while meeting stringent size, weight, power, and cost (SWaP-C) constraints.

Tile-based architectures are a relatively new trend for SWAP-C constrained antenna array systems. In a tile architecture, various radio frequency circuits and a beamformer circuit, such as a beamformer integrated circuit (BFIC), are typically placed on the back of an antenna array printed circuit board (PCB), in a repeatable pattern consistent with regular (rectangular or staggered) placement of antenna elements that are on the other side. The various modules and chips may compete for limited board space set by the lattice spacing which may be determined by the maximum array frequencies.

Tile-based antenna array architectures present several key challenges. A first challenge involves area constraints due to antenna lattice spacing. Tile solutions, even for frequencies as low as 8 GHZ, are not readily available in the market today, and custom solutions are considered exotic at frequencies above 12 GHz (e.g., X-band and above). A second challenge is manufacturing yield, weight, and cost limitations on the number of antenna array PCB layers that can be used for routing and passive component placements, as one side of the PCB may be dedicated to the antennas and unavailable for components. Further, PCB routing layers are also needed to support the antenna feed network, ground planes, and even the antenna radiators themselves. A third challenge relates to heat flow. For example, heat may not flow down into the antenna PCB board because PCB materials are not good thermal conductors, the antenna side cannot be covered by a heat sink, and the antenna radome creates an insulated zone. Therefore, the primary heat path must be from the side opposing the antenna array (e.g., a top side having RF components). Although challenging, if a tile approach is to be useful, the ability to use high-speed pick-and-place assembly on standard PCB panels with RF components on one side of the board and an easy-to-access thermal plane, may dramatically reduce array cost, minimize calibration and test times, reduce size and weight, and improve reliability.

Thus, there remains a need for tile-based architectures that sufficiently address these complex system design challenges regarding lattice spacing, routing layers and passive placement, and heat extraction, among others.

### SUMMARY

Embodiments of the present disclosure include windowed radio frequency circuit modules for use with tile array packages and methods of configuration, assembly, and use of such modules and packages.

In an exemplary aspect, an apparatus is disclosed. In some embodiments, the apparatus includes a planar laminate having a window, wherein the planar laminate has a first side and a second side. The apparatus may further include a plurality of radio frequency circuit elements interconnected and distributed between the first side and the second side; and a plurality of chip pads on the first side. In addition, the apparatus may be configured to connect to an electronics assembly via the plurality of chip pads, wherein the electronics assembly comprises a beamformer integrated circuit, and wherein the apparatus is configured such that, after connection with the electronics assembly, the beamformer integrated circuit extends into the window.

In another exemplary aspect, a wireless device is disclosed. In some embodiments, the wireless device includes a first electronics assembly and a second electronics assembly. The first electronics assembly may include a laminate having a window; and a transceiver circuit located on the laminate. The second electronics assembly may include a printed circuit board (PCB) having a first side and a second side; a beamformer circuit connected to the PCB on the first side; and a plurality of antennas located on the second side. In addition, the first electronics assembly may be connected to the second electronics assembly such that the beamformer circuit is positioned within the window.

In another exemplary aspect, a method of transmitting wireless signals using a wireless device is disclosed. In some embodiments, the wireless device includes a first electronics assembly and a second electronics assembly. The first electronics assembly may include a laminate having a window; and a transceiver circuit located on the laminate. The second electronics assembly may include a PCB having a first side and a second side; a beamformer circuit connected to the PCB on the first side; and a plurality of antennas located on the second side. In addition, the first electronics assembly may be connected to the second electronics assembly such that the beamformer circuit is positioned within the window. The method may include generating a signal using the beamformer circuit; processing the signal, by the transceiver circuit, to generate a second signal; and transmitting the second signal via the antenna.

Additional aspects, features, and advantages of the present disclosure will become apparent from the following detailed description.

### BRIEF DESCRIPTION OF THE DRAWINGS

The accompanying drawing figures incorporated in and forming a part of this specification illustrate several aspects of the disclosure, and together with the description, serve to explain the principles of the disclosure.

FIG. 1 is a block diagram of a wireless system that uses a hybrid beamforming architecture, according to some aspects of the present disclosure.

FIG. 2 is a schematic diagram of an exemplary transceiver module, according to some aspects of the present disclosure.

FIGS. 3A and 3B are a simplified overhead views of a wireless device, according to some aspects of the present disclosure.

FIGS. 4A and 4B are different detailed perspective exploded views of a wireless device 400, according to some aspects of the present disclosure.

FIG. 5 is a detailed perspective bottom-side view of wireless device after placement of the windowed multi-chip module, according to some aspects of the present disclosure.

FIGS. 6A and 6B are different detailed perspective exploded views of a wireless device, according to some aspects of the present disclosure.

FIG. 7 is a detailed perspective exploded view of another wireless device, according to some aspects of the present disclosure.

FIG. 8 illustrates a method of transmitting signals using a wireless device, according to some aspects of the present disclosure.

### DETAILED DESCRIPTION

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

Exemplary embodiments of radio frequency circuit modules for use with tile array packages are presented herein. Various embodiments of radio frequency circuit modules are designed to have a window or aperture for use with tile antenna array systems having a beamformer circuit, such as a BFIC. In some embodiments, a module having a window is connected to an electronic assembly having a beamformer circuit (e.g., BFIC) and antenna array, where the window surrounds the beamformer circuit.

A windowed radio frequency circuit module, such as a windowed multi-chip module, addresses system design challenges for functional integration within a given lattice spacing constraint, routing layers and passive placement, and heat extraction. Further, windowed multi-chip modules leave the BFIC as a stand-alone IC (of customer choice) separately procured and placed on the antenna board. A windowed multi-chip module provides for the various circuitry implemented thereon (e.g. RF front end circuitry) to encircle or straddle (or stack, or fly-over, or bridge) over a BFIC subsystem, which may be an off-the-shelf BFIC. Further, having a window designed into the multi-chip module allows a direct or indirect thermal path to the BFIC and room for passive components around the BFIC but optimally places the feed-points of the multi-chip module at conveniently close and symmetrical locations.

In addition, having a BFIC sourced and physically separate from a windowed multi-chip module allows an optimal selection of the beamforming functionality among a variety of BFIC vendors according to specific use cases. Moreover, by not including a BFIC as part of the windowed multi-chip module, the proposed solution solves potentially challenging export control limitations for highly integrated RF front-end modules that may be implemented on windowed multi-chip modules. Therefore, new package technology will allow for the supply of multi-chip modules to non-U.S. customers, without hobbling the performance dictated by any potential export control requirements.

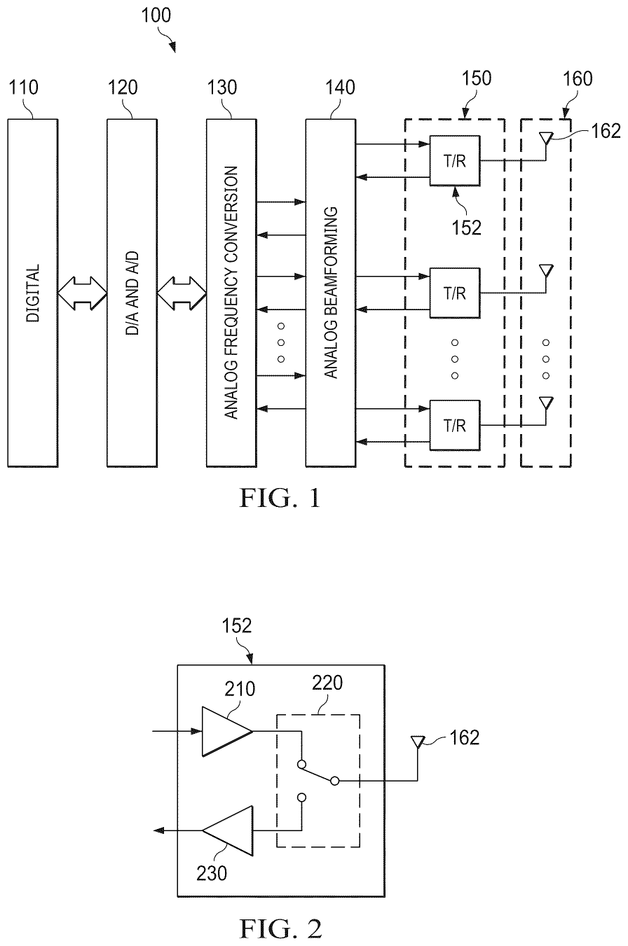

FIG. 1 is a block diagram of a wireless system 100 that uses a hybrid beamforming architecture, according to some aspects of the present disclosure. In this embodiment, the wireless system 100 includes one or more digital processing blocks 110, a conversion block 120, an analog frequency conversion block 130, an analog beamforming circuit 140, a radio frequency circuit module 150, and an antenna array 160 connected as shown. The wireless system 110 may implement a radar device operating at GHz frequencies, for example, or a wireless communication system or device. In some embodiments, the digital processing block 110 performs digital beamforming, digital upconversion for transmitted signals, and digital downconversion for received signals. The processing block 110 may be implemented using one or more processors, such as a baseband process, a general-purpose processor, or an application specific integrated circuit. In some embodiments, the conversion block 120 performs digital-to-analog (D/A) conversion for transmitted signals and analog-to-digital (A/D) conversion for received signals. The conversion block 120 may include a plurality of A/D and D/A converters for this purpose. The analog frequency conversion block 130 may perform analog frequency upconversion for transmitted signals and analog frequency downconversion for received signals. Frequency conversion may be provided for multiple channels.

The analog beamforming circuit 140 receives a multi-channel input that includes M channels from analog frequency conversion block 130 and produces a multi-element output that includes N outputs, where N may be greater than M. The number of outputs N may be equal to the number of antenna elements 162 in antenna array 160. The radio frequency circuit module 150 includes multiple transmit/receive (T/R), or transceiver, modules, an exemplary one of which is labeled as 152. Each transceiver module 152 can receive a radio frequency signal from analog beamforming circuit 140 and produce or generate a radio frequency signal for transmitting via an associated antenna, an exemplary one of which is labeled as 162. Each transceiver module 152 can receive a signal from an antenna 162 and produce a signal for the analog beamforming circuit 140. The antenna array 160 includes multiple antennas, an exemplary one of which is labeled as 162.

FIG. 2 is a schematic diagram of an exemplary transceiver module 152, according to some aspects of the present disclosure. In this embodiment, the transceiver module 152 includes a power amplifier 210, a radio frequency switch 220, and a low noise amplifier (LNA) 230. The power amplifier 210 yields a signal ready for transmission via antenna 162. During transmission, the radio frequency switch 220 is in a state to connect the power amplifier 210 to the corresponding antenna 162. The low noise amplifier 230 yields a signal for analog beamforming circuit 140. During reception, the switch 220 is in a state to connect the antenna 162 to the LNA 230. In some embodiments, the switch 220 may be implemented as a conventional GaN device. The radio frequency switch 220 is configured to switch between the power amplifier 210 and the low noise amplifier 230.

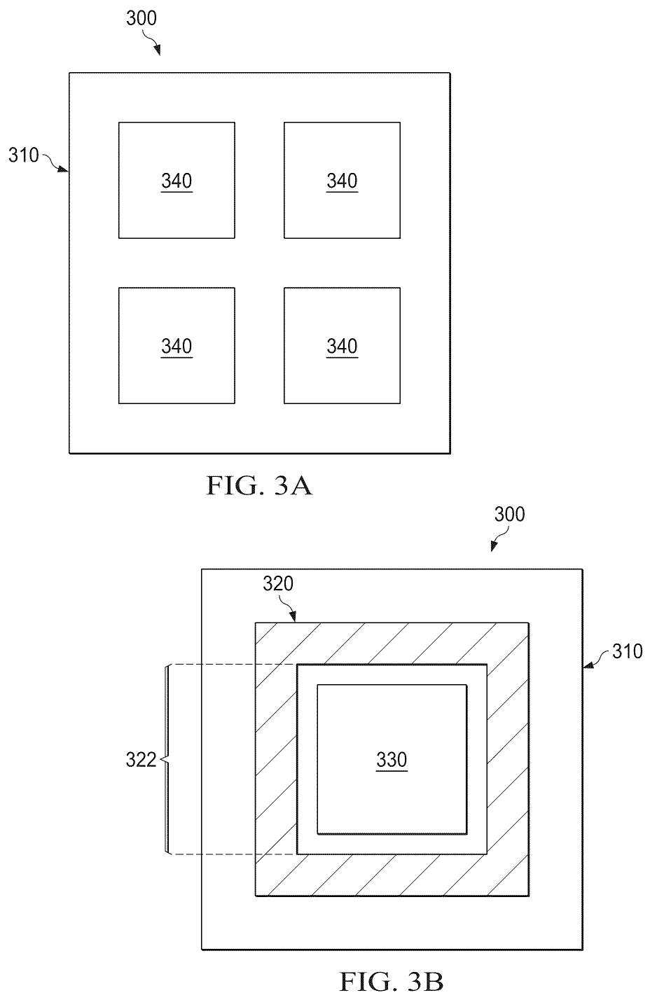

FIGS. 3A and 3B are a simplified overhead views of a wireless device 300, according to some aspects of the present disclosure. For example, wireless device 300 may represent a radar system or a wireless communication device. FIG. 3A is a simplified overhead view of one side of the wireless device 300, and FIG. 3B is a simplified overhead view of the other side of the wireless device 300. As shown in FIG. 3A, the wireless device 300 includes a printed circuit board (PCB) 310 and an antenna array or sub-array positioned thereon. In this embodiment, the antenna array includes four antennas 340, but the antenna array may include any number of antennas positioned on the PCB 310.

The presence of the antennas on one side of the PCB may limit the availability of room for passive component placement and also the number of routing layers for RF, analog and digital interconnects, etc. Additionally, it is beneficial that heat be removed from the top-side of the module where a large metal heat-sink or thermal plate can directly sink from the modules. Extraction from the antenna side is not desirable to avoid blocking antenna radiation pattern or driving exotic lateral thermal solutions into the antenna array PCB stackup. The presence of the module laminate may allow for additional routing layers and some of the passive components can be placed inside the module. This relieves the routing burden on the antenna PCB.

As shown in FIG. 3B, the wireless device 300 further includes a windowed radio frequency circuit module 320 (which may also be referred to as a multi-chip module 320) and a BFIC 330, both connected to the PCB 310 on an opposite side of the PCB 310 from the antenna array. The windowed multi-chip module 320 includes a window or aperture 322. The window 322 allows for placement of the BFIC 330 within the window 322, with the windowed multi-chip module 320 surrounding the BFIC 330. In some embodiments, the windowed multi-chip module 320 includes transceiver radio frequency (RF) front-end modules that connect between the BFIC 330 and the antenna array comprising antennas 340. The window 322 allows the BFIC 330 to be in the center and the front-end modules on the multi-chip module 320 to encircle the BFIC 330 to optimize signal transition locations and minimize trace lengths and save area critical to meet tighter lattice spacing. This design allows the BFIC 330 to be sourced separately from the multi-chip module 320, allowing an optimal selection of beamforming functionality, e.g., according to specific use cases. Moreover, by not including a BFIC 330 as part of the windowed multi-chip module 320, the present embodiment solves potentially challenging export control limitations for highly integrated RF front-end modules that may be implemented on windowed multi-chip modules.

The architecture in FIGS. 3A and 3B may be referred to as a “tiled” antenna array architecture due to the RF circuit elements or network feeding the antenna array being arranged in a manner generally parallel to the array face (shown in FIG. 3A), as the term tiled or tile array package is generally understood in the art and also used herein. The systems and techniques used herein are generally applicable to tile array architectures.

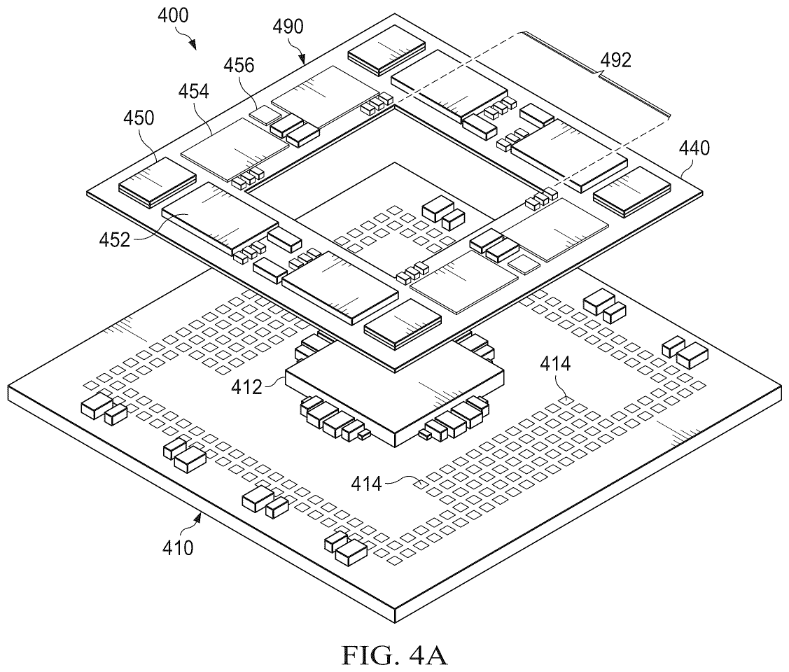

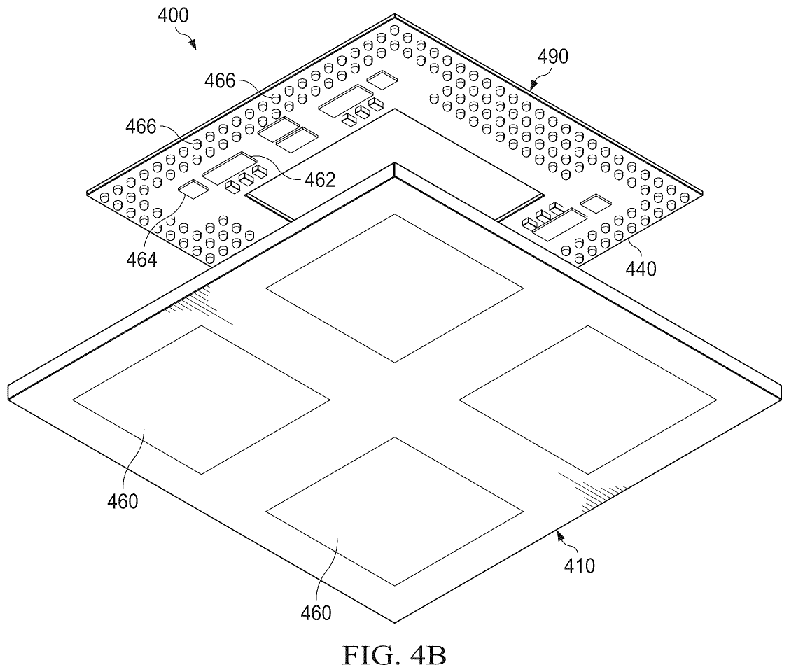

FIGS. 4A and 4B are different detailed perspective exploded views of a wireless device 400, according to some aspects of the present disclosure. In some embodiments, the wireless device 400 may implement a radar device, such as a radar device operating at GHz frequencies or a wireless communication device that engages in two-way communication, as examples. The wireless device 400 includes a PCB 410. The wireless device 400 further includes a BFIC 412, which is electrically connected to the PCB 410. The wireless device 400 further includes a plurality of landing pads 414 spaced around the PCB. In some embodiments, the plurality of landing pads 414 is distributed around the BFIC 412 as shown in FIG. 4A, for example.

As shown in FIG. 4A, the wireless device 400 further includes a windowed multi-chip module 490. The windowed multi-chip module 490 includes various radio frequency circuit elements on a laminate 440. In this embodiment, the multi-chip module 490 includes multiple transceiver modules, one for each of a plurality of antennas (four in this case, as shown in FIG. 4B). The components of one of the transceiver modules are labeled in FIG. 4A. The exemplary transceiver module includes multiple radio frequency circuit elements—an RF switch 450, a power amplifier 452, a control IC 454, and a bias IC 456, all placed on the illustrated side of laminate 440 in this example. The windowed multi-chip module 490 further includes a window 492 sized to accommodate a beamformer IC, such as beamformer IC 412, positioned within the window 492. Beamformer IC 412 may extend into the window 492. The PCB 410 having a BFIC 412 and antennas 460 may be referred to as an electronics assembly, and the windowed multi-chip module 490 may be referred to as another electronics assembly. The RF switch 450 is configured to switch between the power amplifier 452 and the low noise amplifier 462 in a manner similar to RF switch 220. In some embodiments, window 492 is substantially centered in the laminate 440.

FIG. 4B is a different detailed perspective exploded view of the wireless device 400. FIG. 4B may be considered a top-side view, and FIG. 4A may be considered a bottom-side view. As shown in FIG. 4B, multi-chip module 490 further includes additional radio frequency circuit elements—a low noise amplifier 462 and a limiter 464 in this embodiment. The low noise amplifier 462 and the limiter 464 may be part of the transceiver module described earlier. The wireless device 400 further includes four antennas. Two exemplary antennas are labeled as 460. The antennas 460 illustrated in FIG. 4B are patch antennas, but a variety of other antenna structures may be used, including three-dimensional options such as Vivaldi or Flared-notch antennas. By integrating multiple transceiver channels in a single windowed module, such as windowed multi-chip module 490, the DC and control routing can be done inside the module instead of burdening a customer's PCB design. The RF switch 450 is configured to switch between the power amplifier 452 and the low noise amplifier 462 in a manner similar to RF switch 220. The RF switch 450 provides switchable signal paths between the BFIC 412, the power amplifier 452, the low noise amplifier and one of the antennas 460. There are four transceiver circuits on multi-chip module 490, one for each of the four antennas 460, where each of the transceiver circuits in this example includes an RF switch, a power amplifier, a control IC, a bias IC, a limiter, and a low noise amplifier. The laminate 440 has a side facing away from the PCB 410 (e.g., the side with the RF switch 450) and has a side facing towards the PCB 410 (e.g., the side with the low noise amplifier 462). In some embodiments, each of the sides of the laminate 440 are planar (to form a planar laminate 440), and the laminate 440 has a certain thickness.

The multi-chip module 490 further includes an array of solder bumps 466 that are used for electrically connecting the multi-chip module 490 to the PCB 410. The solder bumps 466 are placed on an array of chip pads (not shown) on the multi-chip module 490. During manufacture, the array of solder bumps 466 are aligned with the array of landing pads 414, and the solder bumps 466 are reflowed to establish bonding between the multi-chip module 490 and the PCB 410. The solder bumps 466 can be used to form a connection between the chip pads on the multi-chip module 490 and the landing pads 414 on the PCB 410. In some embodiments, the chip pads (and solder bumps 466) are distributed around the window 492, as shown in FIG. 4A, for example.

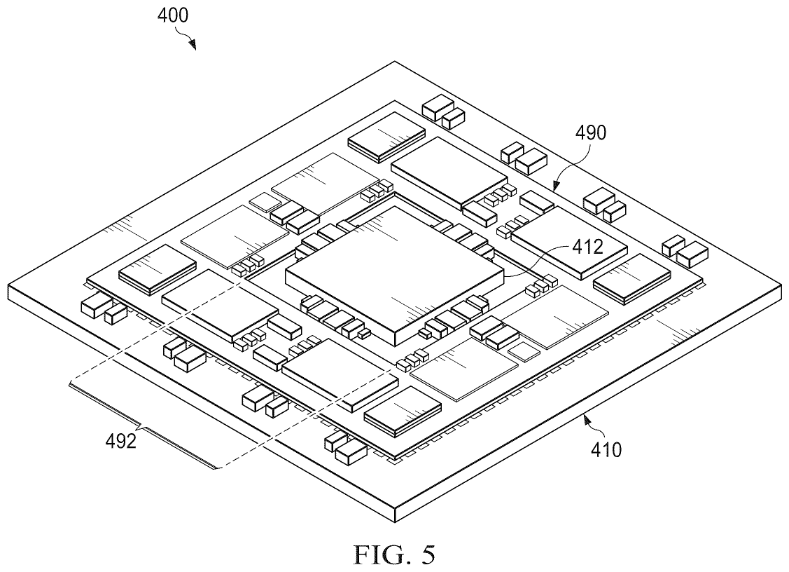

FIG. 5 is a detailed perspective bottom-side view of wireless device 400 after placement of the windowed multi-chip module 490, according to some aspects of the present disclosure. In some embodiments, following the RF signal path, the low power input transmit signal comes through a feed network on the antenna array PCB 410, into the packaged BFIC 412, back out to the PCB 410, up into the windowed multi-chip module 490, back into the antenna PCB 410 feeds and finally out to the antenna radiators 460. In some embodiments, the BFIC 412 implements a hybrid beamforming architecture or implements a digital beamforming architecture, such that the wireless device 400 implements an active electronically scanned array system.

The window in a multi-chip module, such as multi-chip module 490, can be left open to allow multi-level pedestal-based heat-sink thermal solutions to directly contact both the BFIC and the multi-chip module, which may be a thermally enhanced top-side heat removal module.

Or an exposed heat-spreading lid of the windowed multi-chip module can be “plugged” such that it creates a pocket that contacts the BFIC itself and with appropriate thermal interface materials to create a unified thermal plane to better control and distribute heat to the secondary heat sink.

According to some embodiments, a lattice spacing constraint limits the useful area for RF components and routing. For example, at 10 GHz, the center to center antenna spacing is only 15 mm. More functionality (more channels) may be integrated inside the module, including bias and control power management ICs. As an example, for a 2×2 antenna array or sub-array, a four-channel transceiver module plus beamformer IC may be required to fit behind the four antennas (with limit of 20×20 mm for the specific 10 GHz example). For dual-polarization system the number of required transceiver channels may be eight, for the same area constraint.

According to some embodiments, as the number of antennas scales, the antennas may be divided into sub-arrays, with each of the sub-arrays having an associated BFIC and windowed multi-chip module. For example, an array of sixteen antennas may be divided into four sub-arrays of four antennas, with each of the sub-arrays having an associated BFIC and windowed multi-chip module.

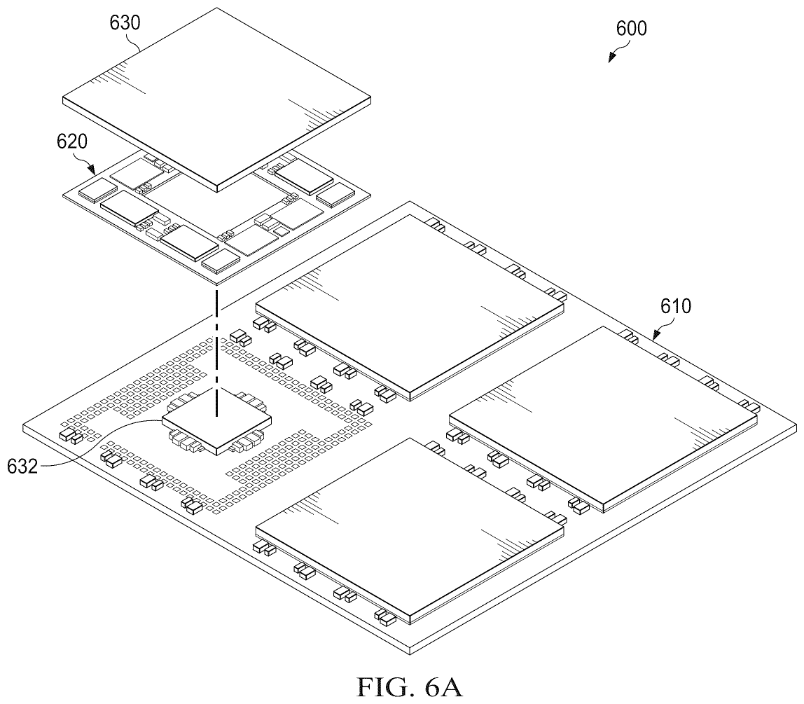

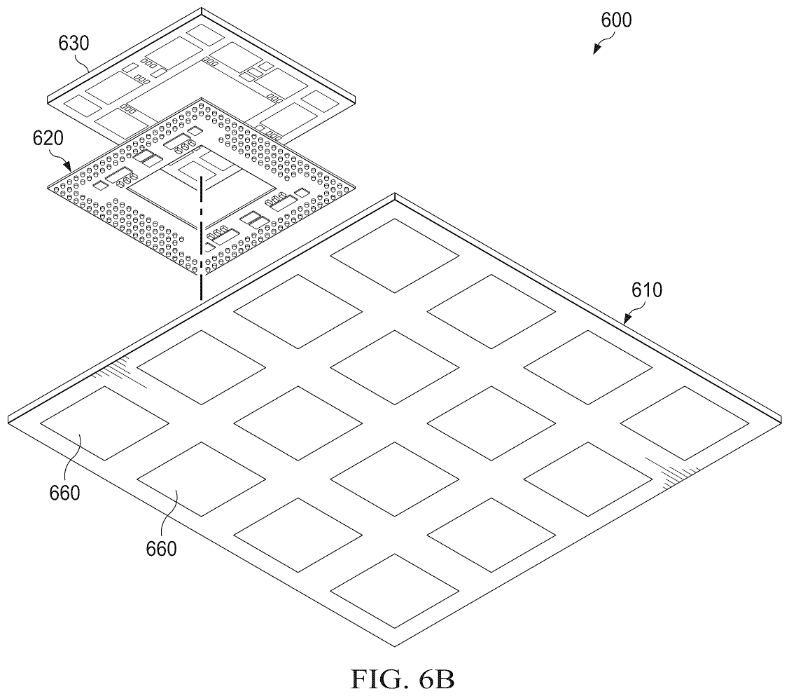

FIGS. 6A and 6B are different detailed perspective exploded views of a wireless device 600, according to some aspects of the present disclosure. FIG. 6A is a bottom-side view of wireless device 600, and FIG. 6B is a top-side view of wireless device 600. As shown in FIG. 6A, wireless device 600 includes four windowed multi-chip modules and BFICs covered by four heat spreaders. An exploded view of one representative beamformer IC 632, windowed multi-chip module 620, and heat spreader 630 is shown in FIG. 6A. The heat spreader 630 may be configured to touch the circuitry on windowed multi-chip module 620 and the BFIC 632 to channel heat from these devices. The heat spreader 630 may be glued on using thermally conducting material.

As shown in FIG. 6B, sixteen antennas are attached to PCB 610. A representative pair of antennas is labeled as 660. The antennas may be divided into 2×2 sub-arrays, each of which has an associated BFIC and windowed multi-chip module, as shown in FIGS. 6A and 6B. There may be a head spreader, such as heat spreader 630, positioned over each 2×2 sub-array, or there may be a single larger heat spreader for the entire wireless device 600. The heat spreader 630 may be a metal lid that is exposed and covers the window of the windowed multi-chip module 620 to form a pocket that is engineered to thermally interface with the BFIC 632. The heat spreader 630 may be made of metal or any other thermally conductive material that channels heat away from BFIC 632 and the windowed multi-chip module 620.

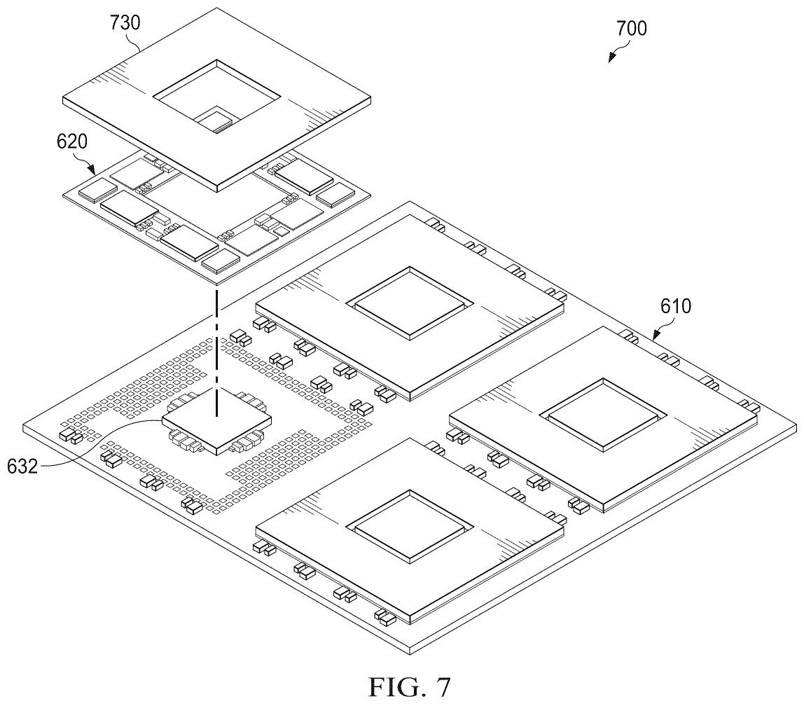

FIG. 7 is a detailed perspective exploded view of another wireless device 700, according to some aspects of the present disclosure. The wireless device 700 is identical to wireless device 600, except for the embodiment of heat spreader used. In the embodiment of wireless device 700, a heat spreader 730 is used that includes a window. The window in the heat spreader 730 is configured to be located above the BFIC 632 when positioned to be in thermal contact with the windowed multi-chip module 620. The window in heat spreader 730 allows an external secondary thermal plane/pedestal (not shown) to separately touch down on top of the BFIC 632. In some cases, this heat spreading arrangement can be simpler and allows an added option of independent control of the thermal plane for silicon integrated circuits (e.g., the BFIC 632) versus other III-V semiconductor devices that are generally designed to tolerate more heat. The heat spreader 730 in this embodiment is in thermal contact (e.g., touching) the circuitry on windowed multi-chip module 620 facing the heat spreader 730 but not in thermal contact with the BFIC 632.

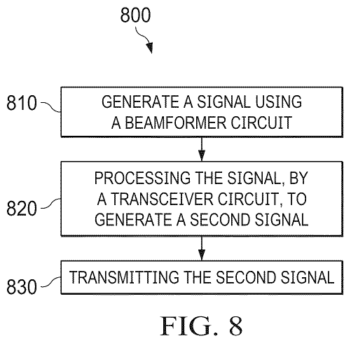

FIG. 8 illustrates a method 800 of transmitting wireless signals using a wireless device, according to some aspects of the present disclosure. In some embodiments, the wireless device may be any of wireless devices 300, 400, 600, or 700 or any wireless device that uses a windowed multi-chip module connected to an electronics assembly that includes a beamforming circuit, and a plurality of antennas forming an antenna array. The method 800 is described here with reference to the wireless system 400. In step 810, a signal is generated by a beamformer circuit, such as BFIC 412. The signal may be generated as part of an overall wireless system, such as wireless system 100, in which the BFIC 412 implements analog beamforming 140. In step 820, the signal may be processed by a transceiver circuit on an electronics assembly (such as a multi-chip module 490), such as the transceiver circuit described with respect to FIGS. 4A and 4B (e.g., a transceiver circuit having an RF switch, a power amplifier, a low noise amplifier, etc.). The signal may travel from a PCB (e.g., PCB 410) to a multi-chip module for processing. The transceiver circuit generates a second signal from the signal. The second signal may travel from the transceiver circuit in the multi-chip module back to the PCB and to an antenna, such as antenna 460, for transmission. The electronics assembly includes a window, such as window 492, that surrounds a beamformer circuit, such as BFIC 412, as shown in FIG. 5, for example. In step 830, the second signal is transmitted, e.g., via one or more antennas. As would have been understood, received signals follow the reverse path—antenna to transceiver to BFIC.

Persons skilled in the art will recognize that the apparatus, systems, and methods described above can be modified in various ways. Accordingly, persons of ordinary skill in the art will appreciate that the embodiments encompassed by the present disclosure are not limited to the particular exemplary embodiments described above. In that regard, although illustrative embodiments have been shown and described, a wide range of modification, change, and substitution is contemplated in the foregoing disclosure. It is understood that such variations may be made to the foregoing without departing from the scope of the present disclosure. Accordingly, it is appropriate that the appended claims be construed broadly and in a manner consistent with the present disclosure.

What is claimed is:

1. An apparatus comprising:
a planar laminate having a window, wherein the planar laminate has a first side and a second side;
a plurality of radio frequency circuit elements interconnected and distributed between the first side and the second side; and
a plurality of chip pads on the first side,
wherein the apparatus is configured to connect to an electronics assembly via the plurality of chip pads, wherein the electronics assembly comprises a beamformer integrated circuit, and wherein the apparatus is configured such that, after connection with the electronics assembly, the beamformer integrated circuit extends into the window.

2. The apparatus of claim 1, wherein the electronics assembly further comprises a plurality of antennas, and wherein the plurality of radio frequency circuit elements are configured to connect between a first antenna of the plurality of antennas and the beamformer integrated circuit.

3. The apparatus of claim 1, wherein plurality of radio frequency circuit elements comprises a low noise amplifier, a power amplifier, and a radio frequency switch, and wherein the radio frequency switch is configured to switch between the low noise amplifier and the power amplifier.

4. The apparatus of claim 1, wherein the apparatus is further configured such that, after connection with the electronics assembly, the window surrounds the beamformer integrated circuit.

5. A wireless device comprising:
the apparatus of claim 2;
the electronics assembly; and
a heat spreader,
wherein the apparatus is connected to the electronics assembly, and wherein the heat spreader is in thermal contact with the radio frequency circuit elements of the plurality of radio frequency circuit elements located on the second side.

6. The apparatus of claim 1, wherein the electronics assembly further comprises a plurality of antennas, and wherein the plurality of radio frequency circuit elements are configured to provide signal paths between each of the plurality of antennas and the beamformer integrated circuit.

7. The apparatus of claim 6, wherein the signal paths include a signal path for transmission, wherein the signal path for transmission is routed from the beamformer integrated circuit to the apparatus and then to an antenna in the plurality of antennas.

8. The apparatus of claim 1, wherein the plurality of chip pads are distributed around the window on the first side, and wherein, after connection with the electronics assembly, the plurality of chip pads are distributed around the beamformer integrated circuit.

9. A wireless device comprising:
a first electronics assembly comprising:
a laminate having a window; and
a transceiver circuit located on the laminate;
a second electronics assembly comprising:
a printed circuit board (PCB) having a first side and a second side;
a beamformer circuit connected to the PCB on the first side; and
a plurality of antennas located on the second side,
wherein the first electronics assembly is connected to the second electronics assembly such that the beamformer circuit is positioned within the window.

10. The wireless device of claim 9, wherein the transceiver circuit is connected on a signal path between the beamformer circuit and a first antenna of the plurality of antennas.

11. The wireless device of claim 9, wherein the transceiver circuit comprises a low noise amplifier, a power amplifier, and a radio frequency switch, and wherein the radio frequency switch is configured to switch between the low noise amplifier and the power amplifier.

12. The wireless device of claim 9, wherein the window surrounds the beamformer circuit.

13. The wireless device of claim 12, further comprising a heat spreader, wherein the heat spreader is in thermal contact with the beamformer circuit.

14. The wireless device of claim 12, further comprising a heat spreader, wherein the heat spreader includes a window located above the beamformer circuit.

15. The wireless device of claim 10, further comprising a second transceiver circuit located on the laminate, wherein the second transceiver circuit is connected between the beamformer circuit and a second antenna of the plurality of antennas.

16. The wireless device of claim 9, wherein the second electronics assembly further comprises a plurality of landing pads distributed around the beamformer circuit on the first side, wherein the first electronics assembly is connected to the second electronics assembly via the plurality of landing pads.

17. A method of transmitting wireless signals using a wireless device, wherein the wireless device comprises:
a first electronics assembly comprising:
a laminate having a window; and
a transceiver circuit located on the laminate;
a second electronics assembly comprising:
a printed circuit board (PCB) having a first side and a second side;
a beamformer circuit connected to the PCB on the first side; and
an antenna located on the second side,
wherein the first electronics assembly is connected to the second electronics assembly such that the beamformer circuit is surrounded by the window, wherein the method comprises:
generating a signal using the beamformer circuit;
processing the signal, by the transceiver circuit, to generate a second signal; and
transmitting the second signal via the antenna.

18. The method of claim 17, wherein the second electronics assembly further comprises a plurality of landing pads distributed around the beamformer circuit on the first side, wherein the first electronics assembly is connected to the second electronics assembly via the plurality of landing pads.

19. The method of claim 17, wherein the first electronics assembly further comprises a second transceiver circuit located on the laminate, wherein the second electronics assembly further comprises a second antenna located on the second side, and wherein the method further comprises:
generating a third signal using the beamformer circuit;
processing the third signal, by the second transceiver circuit, to generate a fourth signal; and
transmitting the fourth signal via the second antenna.

20. The method of claim 19, wherein the second signal and the fourth signal combine to form a beam.

21. The method of claim 18, wherein the first electronics assembly includes a plurality of chip pads distributed around the window, and wherein the plurality of landing pads are aligned and connected to with the plurality of chip pads.
